(19) United States
(12) Patent Application Publication
(10) Pub. No.: US 2024/0307879 A1
(43) Pub. Date: Sep. 19, 2024

(54) FLOW CYTOMETRY DEVICE

(71) Applicant: SINGAPORE UNIVERSITY OF TECHNOLOGY AND DESIGN, Singapore (SG)

(72) Inventors: Ye AI, Singapore (SG); Jianwei ZHONG, Singapore (SG)

(21) Appl. No.: 18/562,436

(22) PCT Filed: May 27, 2022
(86) PCT No.: PCT/SG2022/050363

§ 371 Date: Nov. 20, 2023

(30) Foreign Application Priority Data
May 27, 2021 (SG) 10202105641V

(51) Int. Cl. B01L 3/00; G01N 15/10; G01N 15/1031

(52) U.S. Cl. CPC B01L 3/502761; G01N 15/1031; B01L 2200/0652; B01L 2300/0645; G01N 2015/1006

(57) ABSTRACT

The invention relates to an impedance-based microfluidic flow cytometry device and a method of use thereof for determining a characteristic of a particle in a fluid suspension. Said device comprising: a channel comprising a sensing region to sense a particle flowing through the channel; an electrode arrangement disposed adjacent the sensing region, wherein the electrode arrangement is configured to generate at least one first region of differential current and at least one second region of differential current, and wherein the at least one first region and at least one second region have opposite phases of electric current. The electrode arrangement may be a double differential configuration having 5 electrodes in a coplanar arrangement, comprising a central electrode, two ground electrodes disposed adjacent the central electrode on opposite sides of the central electrode, and two end electrodes disposed adjacent the ground electrodes on the sides opposite to the central electrode.

The present invention relates generally to the field of flow cytometry. In particular, the invention relates to an impedance-based microfluidic flow cytometry device. The invention also relates to a method of determining a characteristic of a particle using the flow cytometry device.

In recent years, studies on the size distribution of a variety of biological samples from submicron to microscale have been drawing great attention for broad biomedical research and clinical applications. For instance, accurate sizing and counting of bacteria are critical in antimicrobial susceptibility tests and antimicrobial resistance studies. The size distribution of most common bacteria has been reported in a range of submicron to micro-scale. In addition to bacteria, apoptotic bodies fragmentized from cells in apoptosis, with a size range of 0.5 to 5 μm, have been discovered to be related to immunoregulation and tumorigenesis. For example, the size distribution of apoptotic bodies in blood plasma relates to ischemic stroke and neurodegenerative diseases; and apoptotic bodies of T lymphocytes promote cell clearance and intercellular communication. Characterizing and quantifying the aforementioned biological samples requires accurate measurements with submicron precision.

Optical microscopy and image-based methods are conventional techniques for microparticle sizing and identification, which are however laborious and time-consuming. Another approach of Brownian motion detection with light scattering for microparticle sizing and counting, has been employed in commercial nanoparticle tracking analyzers (NTA). Commercial NTA achieves high sensitivity and resolution down to nanoscale for nanoparticle detection. However, since its accuracy diminishes for characterizing large particles (>1 μm) due to limited Brownian motion, it is not suitable for sizing and identifying particles in a size range of submicron to microscale. In addition, because the light scattering-based method is sensitive to the movement of objects, it is difficult to probe living biological samples that have self-mobility (e.g., viable bacteria).

Microfluidic flow cytometry has become an ideal candidate for microparticle sizing, counting and identification due to its advantages of single-particle level characterization, high-throughput and small amount of test sample required. High-throughput particle characterization has been demonstrated, such as, for antimicrobial susceptibility testing and cell biophysical phenotyping. In order to perform single-particle/cell characterization, the cross-sectional dimensions of microfluidic channels in flow cytometry are normally designed in a range of μm. This confinement allows particles to be analyzed one by one in microfluidic channels. Current commercial flow cytometry is mostly laser-based, which utilizes a laser light beam to interrogate single microparticles. The size of microparticles can be determined using forward scattering by detecting how much light is blocked from microparticles. Due to the confinement of microfluidic channels in flow cytometry, forward scattering can be used for sizing live biological samples (i.e., bacteria) in microfluidic flow cytometry. However, few studies analyze the minimum resolution quantitatively in submicron particle sizing by forward scattering (FSC). Furthermore, building a laser-based microfluidic system is expensive and complicated. The system also requires calibration and maintenance on beam-focusing points and light-intensity levels, which reduce system robustness and portability.

To overcome the drawbacks, an alternative approach is to use impedance-based microfluidic flow cytometry (IMC). It offers features of label-free, high-throughput and low cost for microparticle sizing, counting, and studying cellular dielectric properties. A typical IMC chip consists of a microchannel filled with a conductive medium and a pair of electrodes connected to an AC voltage source. To suppress electrical noise from conductive medium, differential configurations with coplanar and parallel electrodes were used in previous studies for differentiating cellular phenotypes and sizing microparticles. Several studies have revealed that the electrical current signal between electrodes with a frequency of the applied AC voltage below 1 MHz provides size information of a microparticle passing through the microchannel. However, when a frequency is at sub-MHz, the electric double layer (EDL) effect dominates the measurement of electrical current signals, which could introduce noise to electrical signal leading to a degradation of the signal-to-noise ratio (SNR). In addition to AC voltage applied on electrodes, another factor contributing to the EDL effect is the impedance sensing area of electrodes, which is negatively correlated to the level of the predominance of the EDL effect under the same applied voltage. A previous study has reported an optimized electrode configuration by increasing the sensing area of electrodes. But the configuration requires nanoscale alignment causing difficulty on device fabrication. Decreasing the width of electrodes with fixed length and channel dimensions is normally a choice to increase sensitivity for microparticle detection. However, the diminishment of electrode area leads to a magnification of the adverse EDL effect. A solution for compensating the degradation of the SNR brought by the EDL effect at sub-MHz with a constrained impedance sensing area of electrodes in microfluidic cytometry has not been discussed yet.

There is therefore a need to develop alternative approaches to characterise microscale and submicron particles with submicron precision.

In one aspect of the present invention, there is provided an impedance-based microfluidic flow cytometry device comprising: a channel comprising a sensing region to sense a particle flowing through the channel; and an electrode arrangement disposed adjacent the sensing region, wherein the electrode arrangement is configured to generate within the sensing region at least one first region of differential current and at least one second region of differential current, and wherein the at least one first region and at least one second region have opposite phases of electric current.

As used herein, the term “impedance” or “electrical impedance” refers to a measure of the opposition to the flow of an alternating current. Impedance can be measured by applying a known voltage and measuring the electrical current, or by applying a known electrical current and measuring the resulting voltage.

The term “microfluidics” refers to the behaviour, control and manipulation of particles on a small scale, typically sub-millimetre, in other words on the micro-millimetre or smaller scale. As used herein, the term “impedance-based microfluidic flow cytometry” is meant to include a technique that measure the electrical properties, specifically the impedance properties, of individual particles flowing in a microfluidic channel. An impedance-based microfluidic flow cytometry device may include a plurality of electrodes disposed adjacent the channel to create electric fields within a sensing region of the channel.

The channel may be filled a medium or fluid suspension. In one embodiment, the medium is Phosphate-Buffered Saline (PBS) with a conductivity of about 1.6 S/m.

As used herein, the term “sensing region” may refer to a region within a channel in which one or more differential currents may be generated by electrodes located adjacent to the sensing region, the electrodes being in electrical communication with the sensing region.

As used herein, the term “particle(s)” should be broadly construed to include biological particles and synthetic particles. Examples of biological particles include animal cells, plant cells, bacterial cells, viruses, fungi, as well as other bioparticles such as apoptotic bodies, leukocytes, chromosomes, liposomes, nucleic acids and proteins. The term “particle(s)” may also include synthetic particles such as beads, polymer materials and metals.

The term “phase” as used herein refers to the angle between sinusoidal voltage waveforms or the angle between voltage and current. The terms “phase difference” and “phase angle” are used interchangeably. In the context of an electric current or voltage, the term “opposite phase” refers to a phase difference between the voltage and current of 180° or −180°.

In one embodiment, the electrode arrangement of the device as described herein comprises: a central electrode; two ground electrodes disposed adjacent the central electrode on opposite sides of the central electrode; and two end electrodes disposed adjacent the ground electrodes on the sides opposite to the central electrode, wherein a first region of the at least one first region is generated between each ground electrode and the adjacent end electrode, and wherein a second region of the at least one second region is generated between the central electrode and each adjacent ground electrode.

For example, the electrode arrangement may comprise 5 electrodes in a coplanar arrangement in which the electrodes are arranged symmetrically about the central electrode. In one embodiment, the 5-electrode arrangement comprises a central electrode in the middle, followed by 2 ground electrodes located on either side of the central electrode, and followed by the 2 end electrodes located at the beginning and end of the electrode arrangement.

In various embodiments, the terms “end electrode” and “side electrode” are used interchangeably.

In another embodiment, the electrode arrangement further comprises a floating electrode disposed intermediate a ground electrode and an end electrode.

The term “floating electrode” as used herein is meant to include an electrode that is not connected directly to any voltage source. The floating electrode may be in contact with the fluid in the vicinity of other electrode(s). The presence of a floating electrode modifies the electric field distribution in the vicinity of the floating electrode. The presence of the floating electrodes may be useful for measuring the in-channel height of particles.

In another embodiment, the electrode arrangement further comprises two floating electrodes, wherein each floating electrode is disposed intermediate a ground electrode and an end electrode.

For example, the electrode arrangement may comprise 7 electrodes in a coplanar arrangement in which the electrodes are arranged symmetrically about the central electrode. In one embodiment, the 7-electrode arrangement comprises a central electrode in the middle, followed by 2 ground electrodes located on either side of the central electrode, followed by 2 floating electrodes located on the outer sides of the ground electrodes, and followed by the 2 end electrodes located at the beginning and end of the electrode arrangement. The difference between the 7-electrode arrangement and the 5-electrode arrangement is that the 7-electrode arrangement comprises a pair of floating electrodes, with each floating electrode located between a ground electrode and an end electrode.

In various embodiments, the electrode arrangement may be symmetrical or non-symmetrical. For example, the 5-electrode arrangement and 7-electrode arrangement as described herein are symmetrical.

In one embodiment, the central electrode is connected to an AC voltage source with 0° phase angle and wherein the two end electrodes are connected an AC voltage source with 180° phase angle.

In another embodiment, the electrode arrangement as described herein comprises a further or additional central electrode. Specifically, there can be more than one central electrode. The central electrodes may be disposed alongside each other and intermediate the two ground electrodes.

In various embodiments, the channel is formed in a substrate made of polydimethylsiloxane (PDMS), polymethyl methacrylate (PMMA), polycarbonate, polystyrene, poly(ethylene glycol) diacrylate (PEGDA), cyclic olefin copolymer (COC), or cyclic olefin polymer (COP).

In one embodiment, the electrode arrangement is disposed on a glass substrate and wherein the glass substrate is adjacent the substrate of the channel.

In one embodiment, the dimensions of the channel's cross section in the sensing region is about 3-50 μm in width and about 3-50 μm in height.

In one embodiment, the electrodes are Cr/Au electrodes (10-30 nm/70-200 nm). 10-30 nm refers to the thickness of chromium (Cr) and 70-200 nm refers to the thickness of gold (Au).

In one embodiment, the electrodes are spaced about 1-20 μm apart. In another embodiment, the electrodes are spaced about 5 μm apart.

In one embodiment, the electrodes are about 2-30 μm in width. In another embodiment, the electrodes are about 8-10 μm in width.

In another aspect of the present invention, there is provided a method of determining a characteristic of a particle in a fluid suspension, the method comprising:
(a) providing
   i) a channel for receiving and allowing the fluid suspension to flow through, the channel having a sensing region; and
   ii) an electrode arrangement disposed adjacent the sensing region;
(b) applying a voltage to one or more electrodes in the electrode arrangement to generate within the sensing region at least one first region of differential current and at least one second region of differential current, and wherein the at least one first region and at least one second region have opposite phases of electric current;
(c) obtaining a differential electrical signal generated by the electrode arrangement as the particle flows through the sensing region; and
(d) determining the characteristic of the particle based on the differential electrical signal.

The term “differential electrical signal” as used herein is meant to include an electrical signal formed from the differentiation between two ground electrodes. The terms “differential electrical signal” and “differential current signal” are used interchangeably. A differential electrical signal is generated when a particle flows through the sensing region of the channel. Appropriate processing of the differential electrical signal can be carried out to determine the impedance properties of the particle. Factors that determine the impedance properties of the particle include its size, structure, shape, composition and opacity.

In one embodiment, the electrode arrangement of the method as described herein comprises: a central electrode; two ground electrodes disposed adjacent the central electrode on opposite sides of the central electrode; and two end electrodes disposed adjacent the ground electrodes on the sides opposite to the central electrode, wherein a first region of the at least one first region is generated between each ground electrode and the adjacent end electrode, and wherein a second region of the at least one second region is generated between the central electrode and each adjacent ground electrode.

In another embodiment, the electrode arrangement further comprises a floating electrode disposed intermediate a ground electrode and an end electrode.

In another embodiment, the electrode arrangement further comprises two floating electrodes, wherein each of the two floating electrodes is disposed intermediate a ground electrode and an end electrode.

In one embodiment, step (b) of the method as described herein comprises applying an AC voltage with 0° phase angle to the central electrode and applying an AC voltage with 180° phase angle to the two end electrodes.

In another embodiment, the electrode arrangement as described herein comprises a further or additional central electrode. Specifically, there can be more than one central electrode. The central electrodes may be disposed alongside each other and intermediate the two ground electrodes.

In one embodiment, in step (c) of the method as described herein, the differential electrical signal is received by the two ground electrodes.

In one embodiment, after step (c) of the method as described herein, the differential electrical signal is further differentiated with a differential amplifier. This further differentiation of the differential electrical signal may be known as the secondary active differential stage.

In one embodiment, in the method as described herein, the step of determining the characteristic of the particle comprises determining the size of the particle, wherein the method further comprises a step of calibrating the size of the particle. The first region of differential current, generated between an end electrode and a ground electrode, may provide information regarding the position of the particle. The second region of differential current, generated between a ground electrode and the central electrode, may provide information regarding the electrical size of the particle.

In one embodiment, in the method as described herein, the step of determining the characteristic of the particle comprises determining the quantity of the particle. Determining the quantity of the particle may include counting the particles which are characterised based on their impedance properties. Factors that determine the impedance properties of the particle include its size, structure, shape, composition and opacity. The characteristics of a particle may include the size, structure, shape, composition, opacity, and other optical or mechanical properties of the particles.

In one embodiment, in the method as described herein, the step of determining the characteristic of the particle comprises identifying the particle. Identifying the particle includes the classification of different types of particles based on the characteristics of the particles determined from their impedance properties. Factors that determine the impedance properties of the particle include its size, structure, shape, composition and opacity. The characteristics of a particle may include the size, structure, shape, composition, opacity, and other optical or mechanical properties of the particles.

In various embodiments, the particle is a biological particle. In one embodiment, the biological particle is a cell. In one embodiment, the biological particle is a bacterial cell. In one embodiment, the biological particle is a leukocyte. In one embodiment, the biological particle is an apoptotic body.

In one embodiment, the present invention relates to a label-free high-throughput impedance-based microfluidic device with a novel seven-electrode coplanar configuration for size-profiling microscale and submicron particles with submicron precision. The proposed electrode arrangement is referred to as a double differential configuration with two stages of electrical signal differentiation for noise-cancelling. Compared with typical three-electrode and floating electrodes configurations, the new double differential electrode configuration (i.e., seven-electrode coplanar configuration) achieves the highest sensitivity for particle size measurement down to 0.4 μm precision. A size calibration method may be employed to rectify size information of microparticles and helps to achieve the minimum size resolution down to 200 nm with the IMC system of the present disclosure. In addition, the present invention demonstrates noise-suppression at sub-MHz by compensating the EDL effect, and enables selecting a wide range of frequencies for precise electrical phenotyping while maintaining high SNR. The double differential impedance-based microfluidic cytometry DD-IMC system of the present invention furnishes quantification of various sizes of beads in mixture samples that are in agreement with size information from manufacturers' datasheets. The sizing and quantification of apoptotic bodies has been demonstrated, which shows a consistent concentration measurement and more precise size resolution as compared with commercial fluorescence-based cytometry. Taken together, the developed DD-IMC system can be utilized to profile size distribution, characterize electrical phenotypes, or integrate with downstream sorting for submicron microparticles and biological samples studies.

The listing or discussion of an apparently prior published document in this specification should not necessarily be taken as an acknowledgement that the document is part of the state of the art or is common general knowledge.

Any document referred to herein is hereby incorporated by reference in its entirety.

In order that the present invention may be fully understood and readily put into practical effect, there shall now be described by way of non-limitative examples only preferred embodiments of the present invention, the description being with reference to the accompanying illustrative figures.

In the Figures:

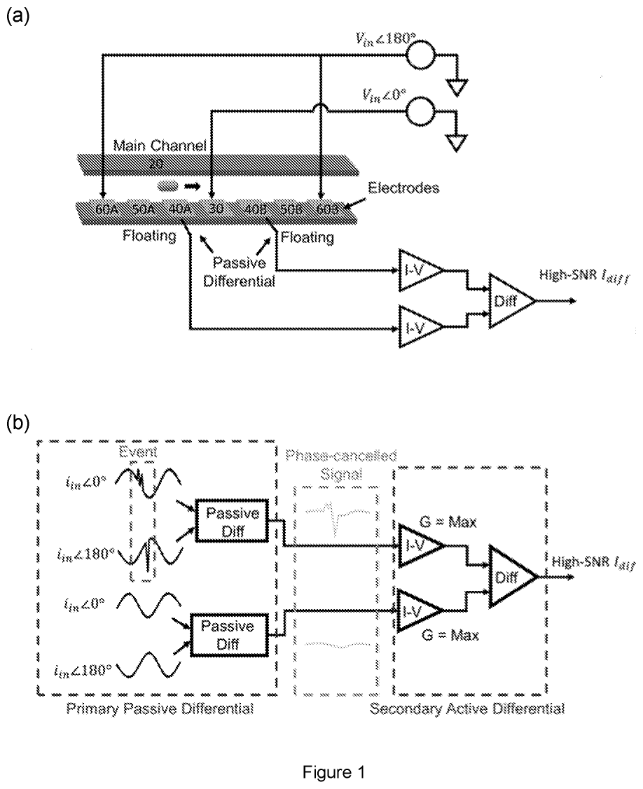

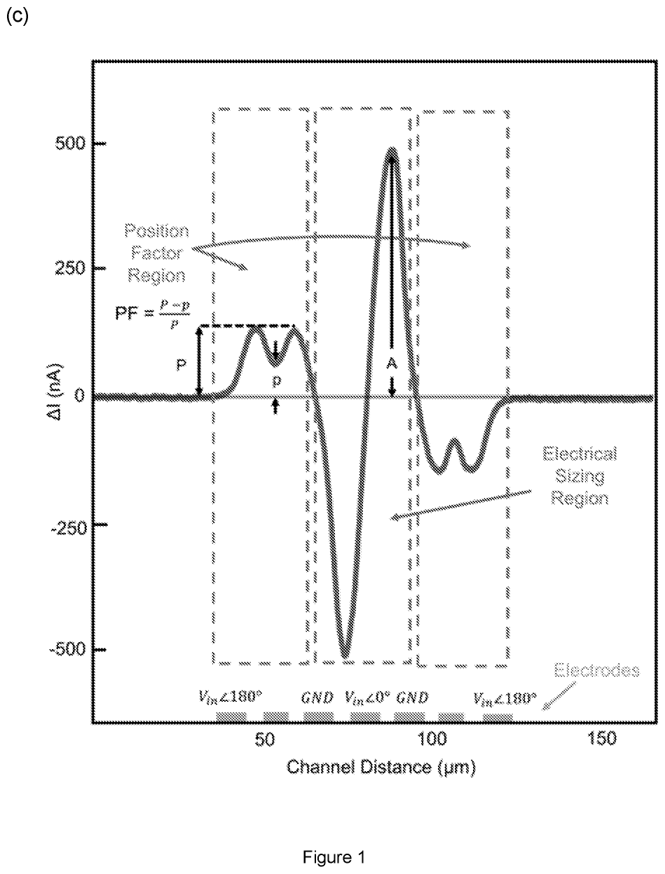

FIG. 1 shows the working mechanism of the double differential microfluidic cytometry device. (a) Electric circuit configuration for the double differential impedance-based flow cytometry system. (b) Electrical current signal path for the for the double differential system. (c) High-SNR differential current signal generated from the double differential system.

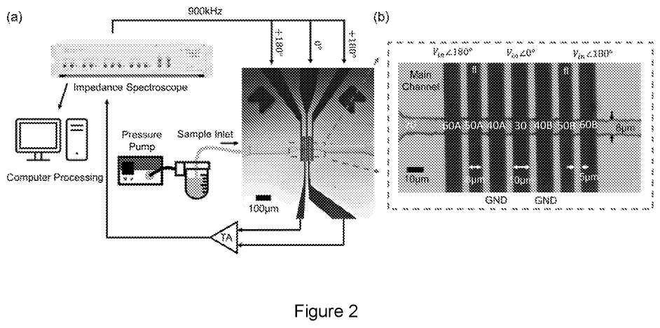

FIG. 2 shows the experimental setup and device design. (a) The double differential impedance-based system configuration. (b) A microscopic image of the impedance sensing channel (fl is denoted as floating electrode).

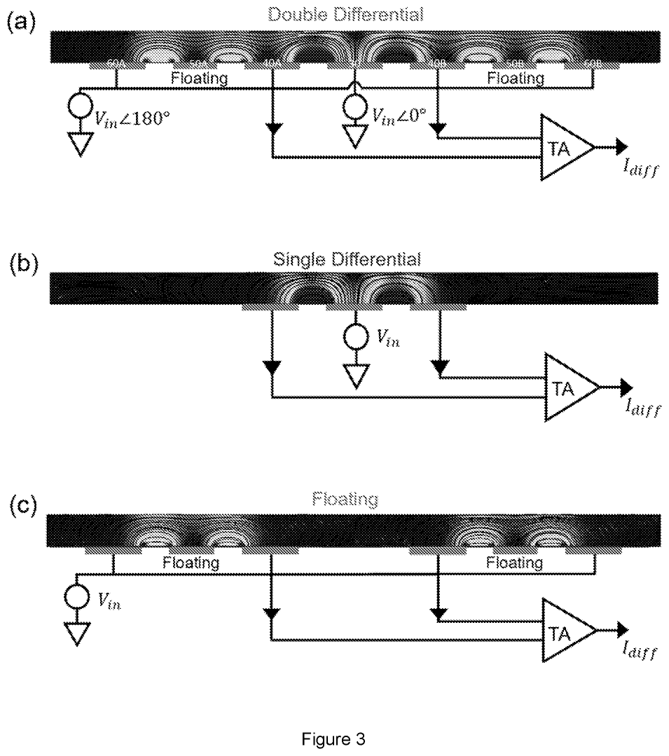

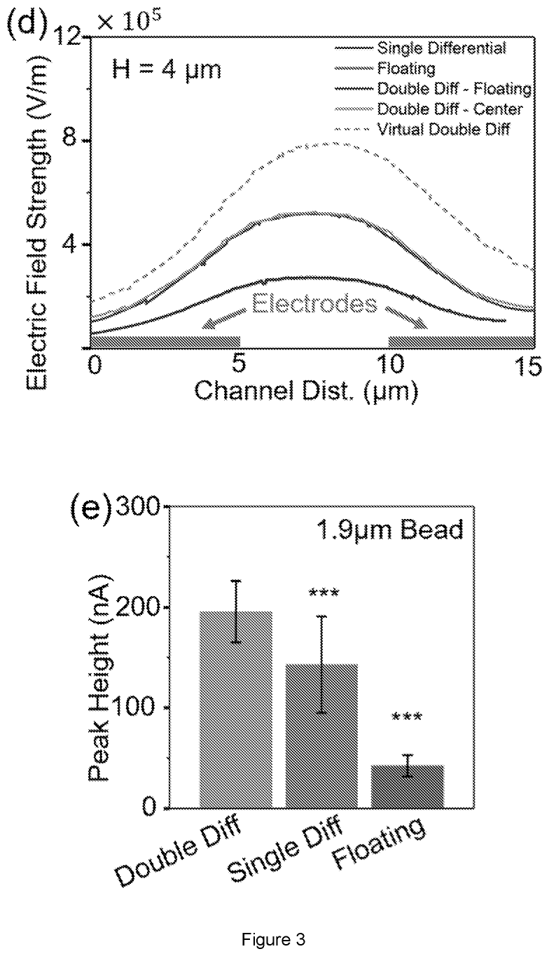

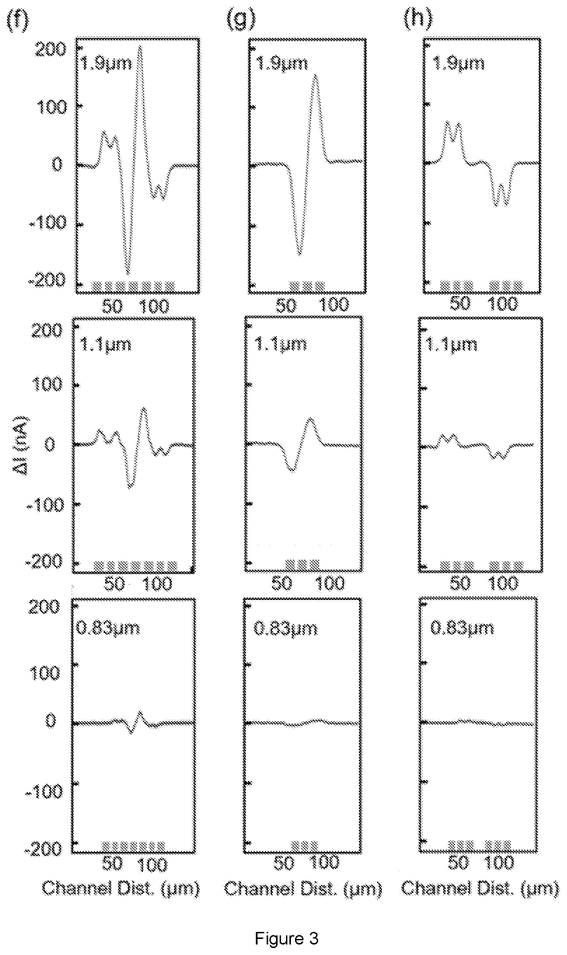

FIG. 3 shows a comparison of electric field strength among the double differential, single differential, and floating electrode configurations. (a)-(c) Side-views of electric field simulation for double differential (a), single differential (b), and floating (c) configurations. (d) Electric field strength at channel height 4 μm. (e) Average peak height of 1.9 μm beads for three types of electrode configurations. (f)-(h) Sample signals of 0.83, 1.1, 1.9 μm beads for three electrode configurations with respect to double differential, single differential and floating. *** p<0.001, by the unpaired two-samples t-test. Error bars represent standard deviation.

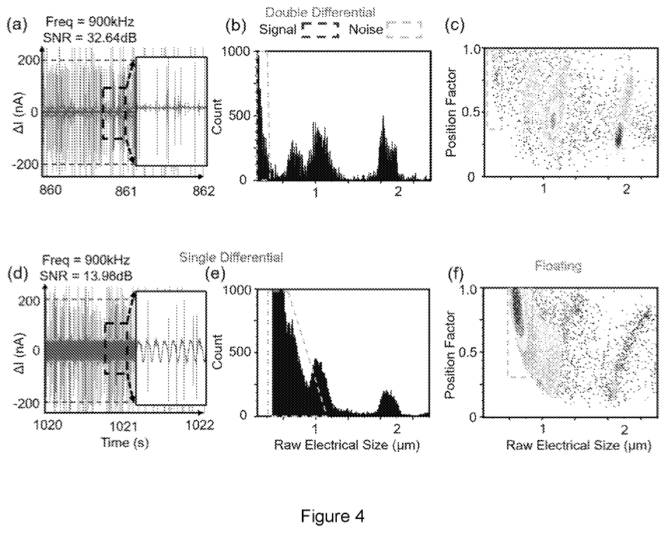

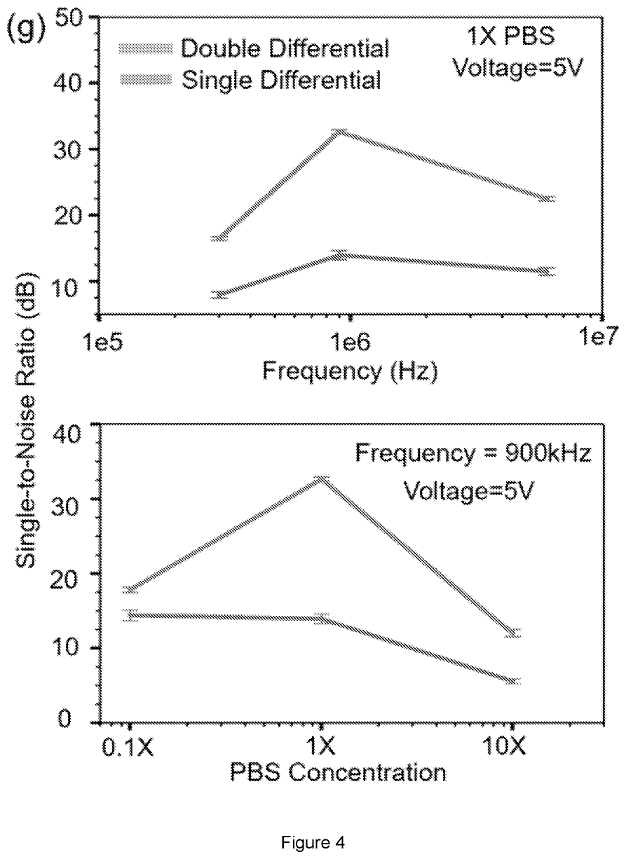

FIG. 4 shows the sensitivity of minimum particle size detection and the SNR comparison for 0.83, 1.1, and 1.9 μm microparticles. (a) A raw impedance signal segment with highlighted signal and noise sampled by double differential electrodes. (b) A histogram of raw electrical size generated from the raw impedance signal with highlighted noise tested by double differential electrodes. (c) A density plot for position factor with respect to raw electrical size with highlighted noise tested by double differential electrodes. (d) A raw impedance signal segment with highlighted signal and noise sampled by single differential electrodes. (e) A Histogram of raw electrical size generated from the raw impedance signal with highlighted noise tested by single differential electrodes. (f) A density plot for position factor with respect to raw electrical size with highlighted noise tested by floating electrodes. (g) SNR with respect to 300 kHz, 900 kHz and 6 MHz. SNR with respect to 0.1×, 1× and 10×PBS. Error bars represent standard deviation.

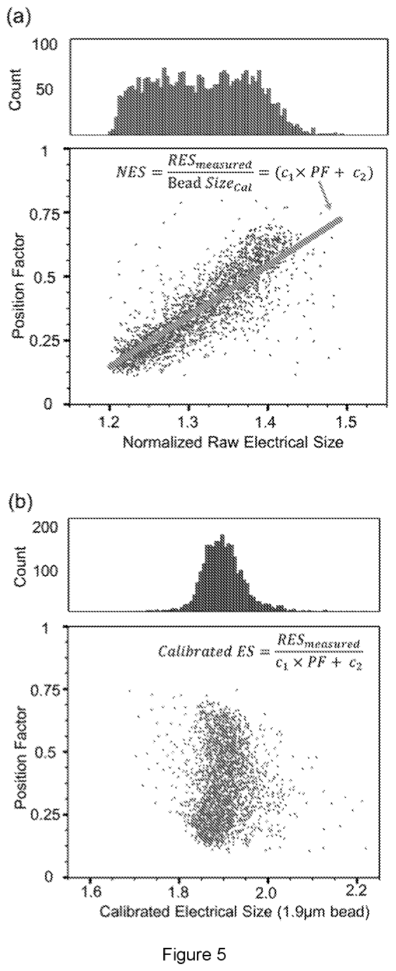

FIG. 5 shows a particle size calibration method. (a) Normalized raw electric size of 1.9 μm fitted with a linear function. (b) Calibrated electrical size of 1.9 μm.

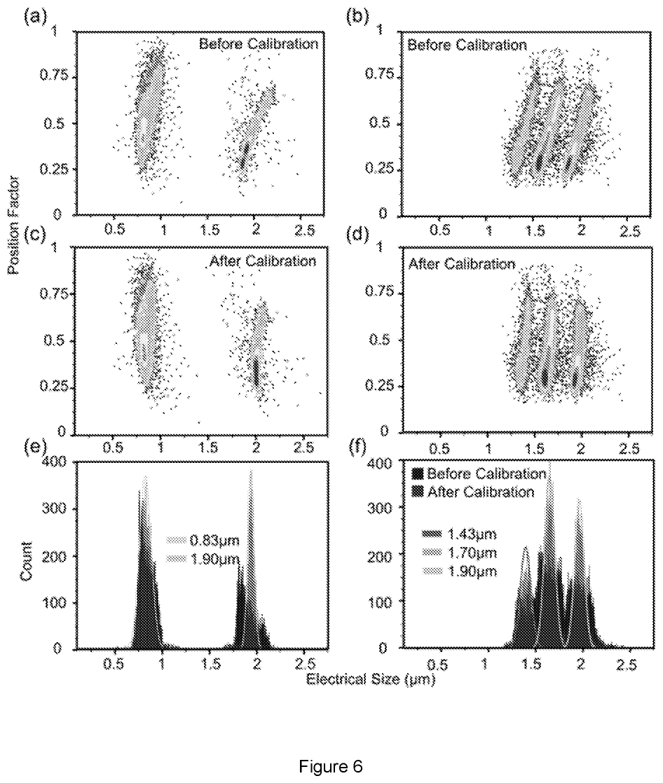

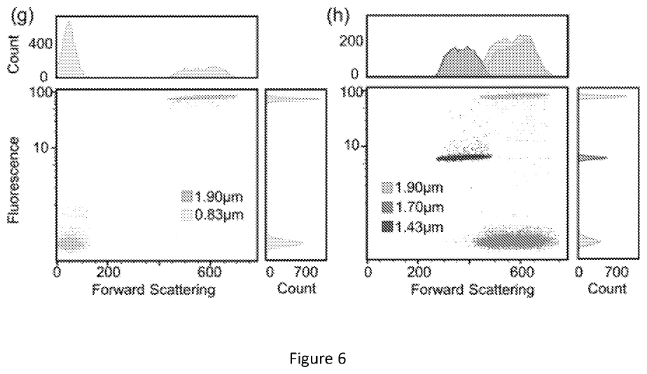

FIG. 6 shows a comparison between before and after size calibration and minimum size resolution. (a)-(b) Electrical size of 0.83, 1.9 μm, and 1.43, 1.7, 1.9 μm with respect to position factor before calibration, and (c)-(d) after calibration. (e)-(f) Histogram of the combining results from before and after calibration, fitted with Gaussian distribution. (g)-(h) Results from a fluorescence-based flow cytometry for both mixture samples.

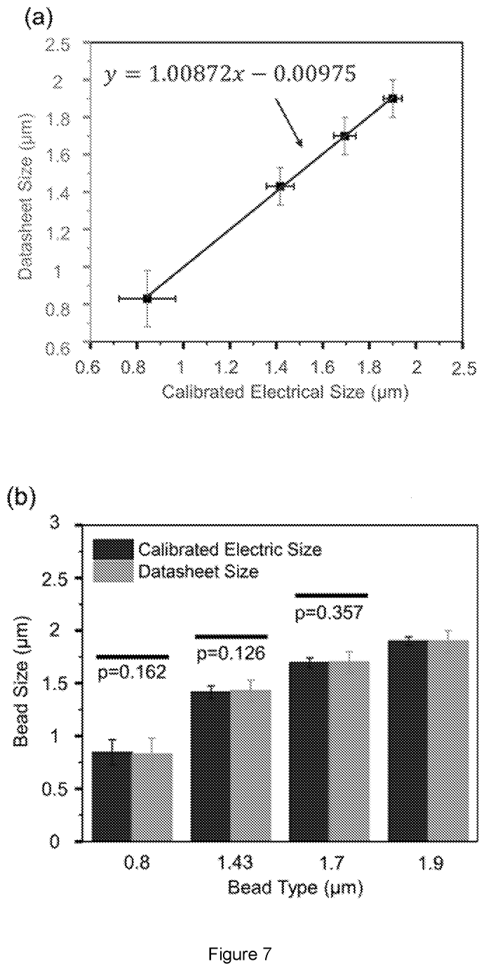

FIG. 7 shows a comparison between particle size measured by the double differential microfluidic device and manufacturers' datasheets. (a) Verifying the calibrated electrical size consistent with datasheet size. (b) Statistical verification between electrical size and datasheet size. Error bars represent coefficient of variation.

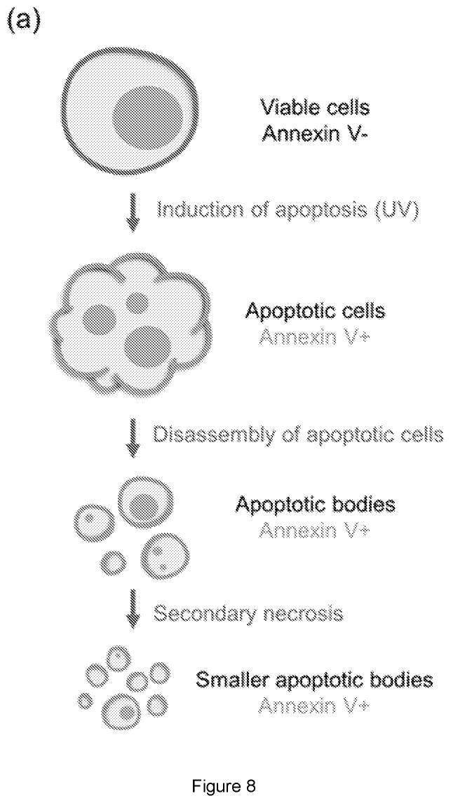

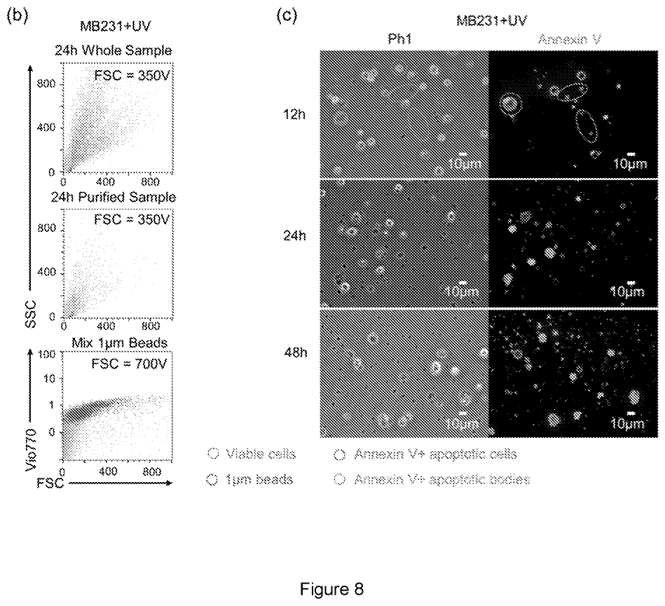

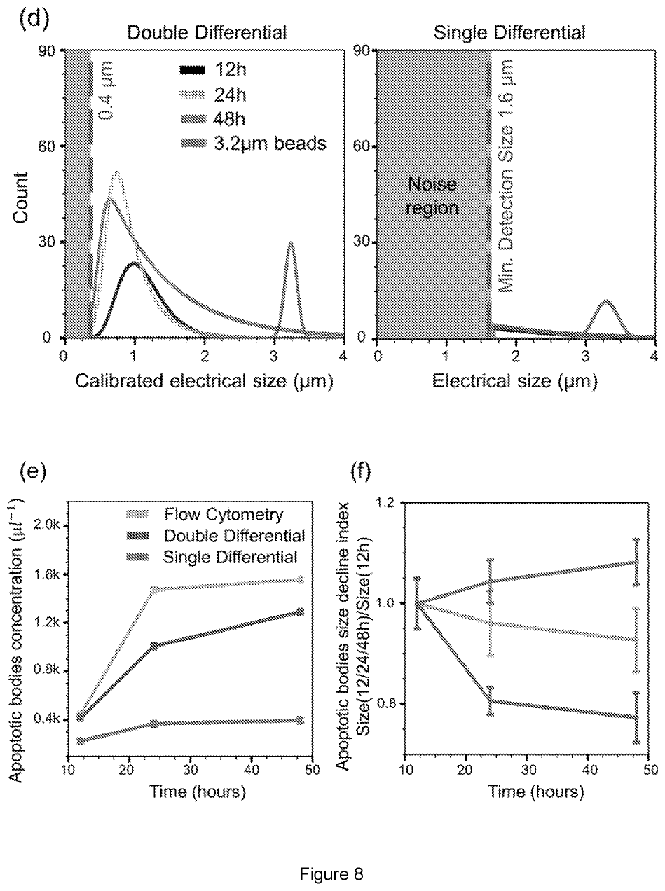

FIG. 8 shows apoptotic bodies of MDA-MB-231 formation timecourse of 48 hours. (a) Schematic of apoptosis progression and apoptotic bodies formation. (b) Flow cytometry analysis shows the size (FSC) of apoptotic bodies in apoptotic bodies-enriched sample is around 1 μm beads. Scatter plots of size (i.e., FSC) and complexity (i.e., SSC) in comparison of whole apoptotic cell sample and apoptotic bodies-enriched sample. (c) Images of UV-induced apoptotic MDA-MB-231 incubated in timecourse of 48 hours. Note the concentration of apoptotic bodies (Annexin V positive) increases with a longer incubation time. (d) Electrical size distribution of apoptotic bodies obtained from double differential electrodes and single differential electrodes calibrated with 3.2 μm beads. (e) Apoptotic bodies concentration recorded in 12, 24 and 48 hours by fluorescence flow cytometry, double differential and single differential impedance cytometry. (f) Size reduction of apoptotic bodies in 12, 24 and 48 hours by fluorescence flow cytometry, double differential and single differential impedance cytometry. Error bars represent standard deviation.

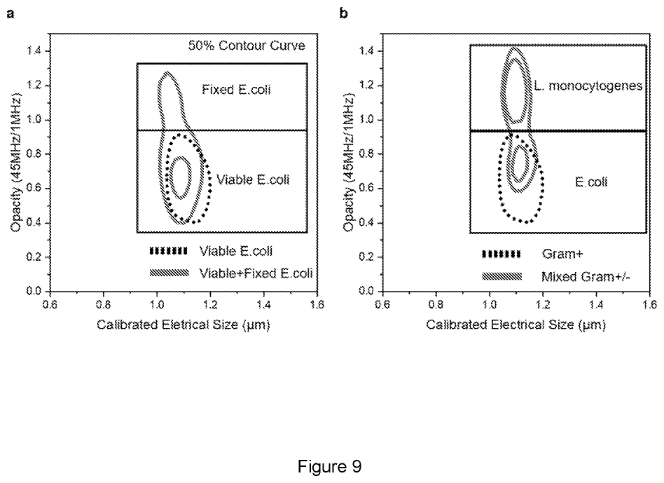

FIG. 9 shows a characterization of E. coli viability and differentiation of gram position and negative bacteria (L. monocytogenes and E. coli). a. Viability assay of viable and fixed E. coli. b. Gram types classification.

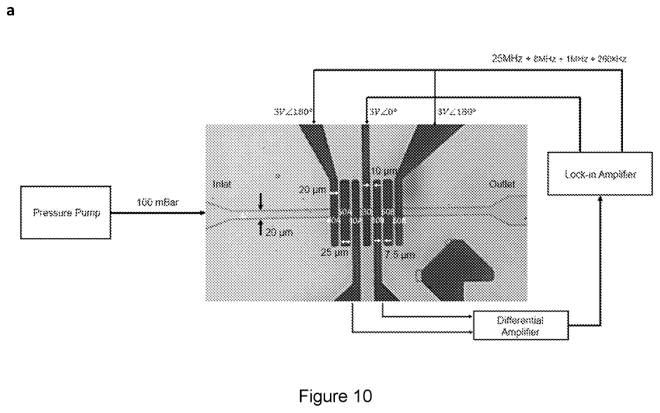

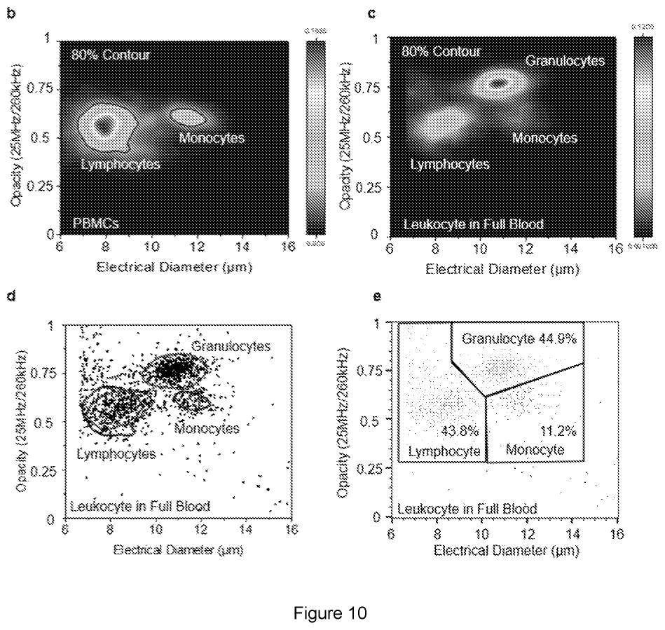

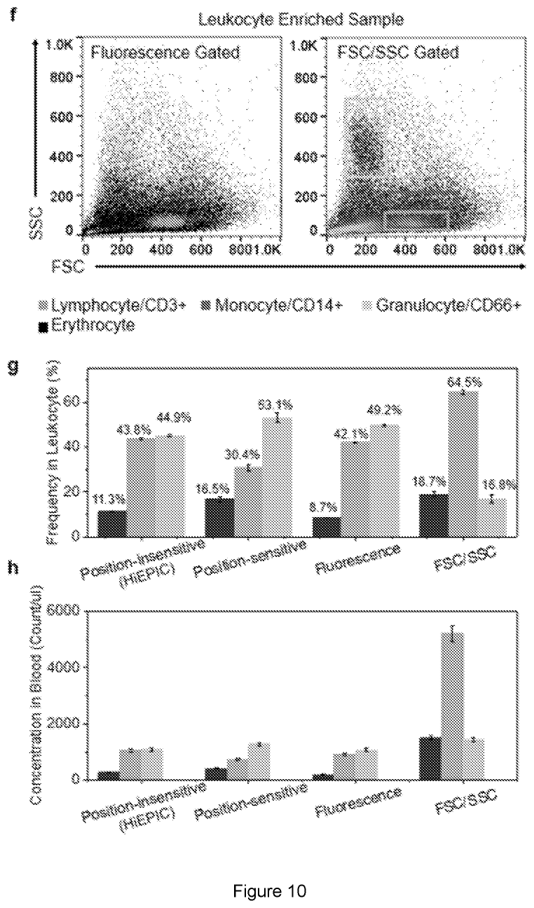

FIG. 10 shows a characterization of 3-part LDC with the double differential electrodes (2 minutes test time counts about 1500 leukocytes). a. The schematic of modified double-differential electrodes for 3-part leukocyte differentiation. b. PBMCs classification with 80% contour curve. c. Leukocytes electrical profiling with 80% contour curve. d. Overlay contour curves from PBMCs and leukocytes for identifying granulocytes. e. 3-part leukocyte classification and quantification. f. Classification from laser-based cytometry in fluorescence-labelling and label-free manners. Note that FSC/SSC gating is based on the location of fluorescence-labelling for subtypes of leukocytes. g-h. Frequencies (% in leukocytes) and concentrations (cells/μl in blood samples) of subtypes in leukocytes (lymphocytes, monocytes, granulocytes) characterized by different approaches. Error bars represent the standard deviation (S.D.).

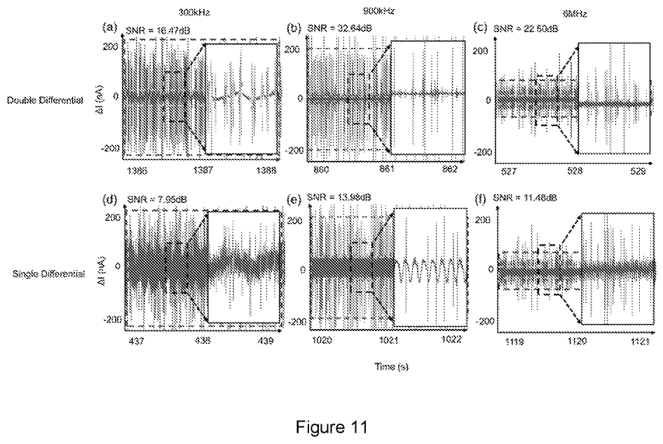

FIG. 11 shows raw impedance signal segments of: (a) double differential at 300 kHz, (b) double differential at 900 kHz, (c) double differential at 6 MHZ, (d) single differential at 300 kHz, (e) single differential at 900 kHz, (f) single differential at 6 MHZ, labelled with SNR.

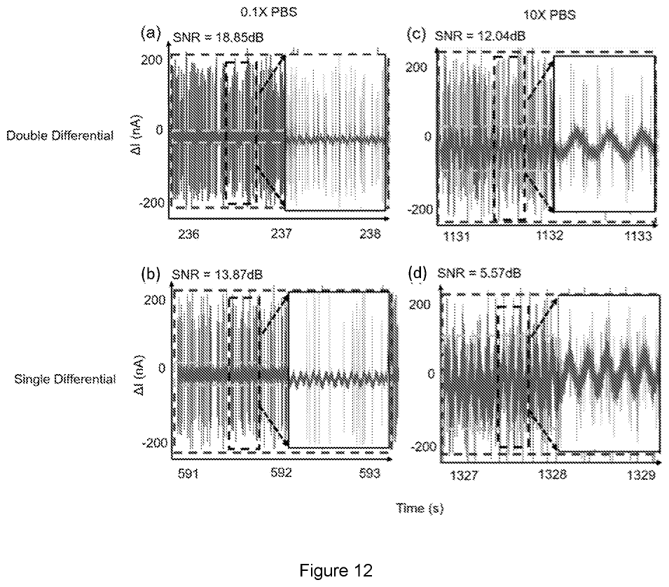

FIG. 12 shows raw impedance signal segments of: (a) double differential in 0.1×PBS, (b) single differential in 0.1×PBS, (c) double differential at 10×PBS, (d) single differential in 10×PBS, labelled with SNR.

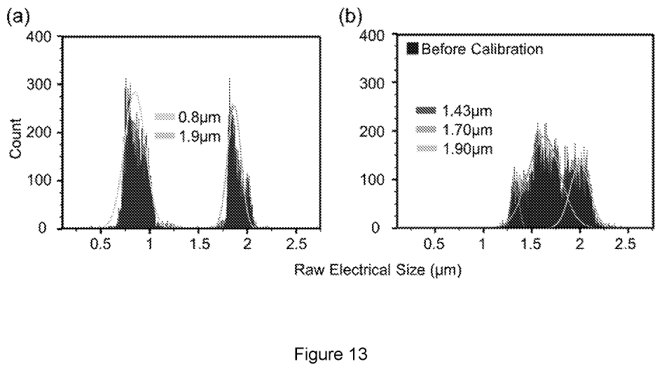

FIG. 13 shows Gaussian fitting of the raw electrical size of the mixture samples: (a) 0.83, 1.9 μm; (b) 1.43, 1.7, 1.9 μm.

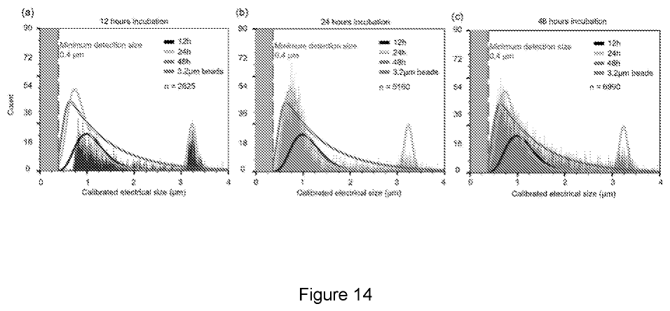

FIG. 14 shows Gaussian fitting of the calibrated electrical size of the apoptotic bodies-enriched sample incubated in (a) 12, (b) 24 and (c) 48 hours. The electrical size is calibrated by the position factor and 3.2 μm beads.

FIGS. 1 to 14 of the present disclosure are also described in Zhong et al. (2021)′ and Zhong et al. (2022)², which are hereby incorporated by reference in their entirety.

The section below describes in detail how the device works in operation.

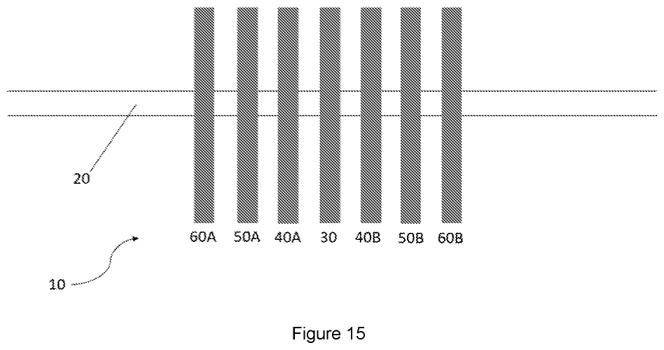

FIG. 15 shows a simplified schematic of a top view of an electrode arrangement 10 according to the present invention. A total of 7 electrodes in a coplanar arrangement are shown disposed adjacent a sensing region of a channel 20. The channel 20 allows particles in a fluid suspension to flow through the device.

From left to right of FIG. 15, the electrode arrangement comprises end electrode 60A, floating electrode 50A, ground electrode 40A, central electrode 30, ground electrode 40B, floating electrode 50B and end electrode 60B. Put another way, central electrode 30 is in the middle of the 7-electrode arrangement, with ground electrodes 40A and 40B disposed on each side of the central electrode 30, followed by floating electrodes 50A and 50B disposed on the outer sides of the ground electrodes 40A and 40B, and finally end electrodes 60A and 60B disposed on the outer sides of the floating electrodes 50A and 50B.

Based on the electrode arrangement shown in FIG. 15, the central electrode 30 connects to an AC voltage source at 0° phase angle. The ground electrodes 40A and 40B connect to I-V converters. The end electrodes 60A and 60B connect to an AC voltage source with opposite phase (180° phase angle). A first region of differential current is generated within the channel 20 between end electrode 60A and ground electrode 40A. A first region of differential current is also generated within channel 20 between end electrode 60B and ground electrode 40B. A second region of differential current is generated within channel 20 between ground electrode 40A and central electrode 30. A second region of differential current is also generated within channel 20 between ground electrode 40B and central electrode 30. The first region(s) of differential current has an opposite phase to the second region(s) of differential current. The double differential configuration can be achieved with the following 5 electrodes: end electrodes 60A and 60B, ground electrodes 40A and 40B, and central electrode 30. The presence of floating electrodes 50A and 50B provides information for measuring the in-channel height of a particle.

As a particle in a fluid suspension flows through channel 20, a differential electrical signal is generated. This differential electrical signal may be divided into two regions: the position factor region and electrical sizing region. The differential electrical signal is transmitted to a differential amplifier in the impedance spectroscope and sent to a computer for signal processing to provide information on the characteristics of the particle.

### Materials and Methods

### Operating Principle

FIG. 1a demonstrates the electrical circuitry configuration of the DD-IMC system, which consists of a main channel embedded with seven electrodes and surrounding circuitry and electronic devices. The channel is filled with a highly conductive medium. The central electrode connects to an AC voltage source at 0° phase angle with two neighbouring ground (GND) electrodes that connect to I-V converters. It is worth noting that there are two extra electrodes located at the beginning and end of the sensing channel. They connect to another voltage source with the same AC voltage amplitude but opposite phase (180° phase angle). Between the electrode applied opposite phase voltage and the GND electrode, there is a floating electrode served for particle size calibration. Two stages of electrical current signal differentiation are performed (FIG. 1b). The first stage is defined as the primary passive differential stage, in which two AC current signals having the same amplitude and frequencies but opposite phase angles, are summed to be zero when there is no particle flowing through the electrodes. As a microparticle passes through the channel, it causes a change of current signal between electrodes. The change of electrical current signal is defined as an event (FIG. 1b), which is carried on the electrical current signal between electrodes in the channel. The frequencies of the current signals in FIG. 1b are below 1 kHz in order to manifest the superposition of the event and signals. The actual experimental setting will be illustrated below. The event becomes distinct due to opposite phase cancellation in the primary passive differential stage. The electrical current is filtered as a phase-cancelled signal (FIG. 1b). Furthermore, because of the restrained peak-to-peak current amplitude of the baseline of the phase-cancelled signal, amplifiers in the I-V converters could be set with a maximized gain avoiding voltage clipping to realize the largest electrical signal amplitude of events. Then, the electrical current signal can be further differentiated with a differential amplifier to remove electrical noise from medium and intrinsic electrical noise from I-V converters, defined as the secondary active differential stage. Thus, the final electrical signal can be profiled as a high signal-to-noise ratio (SNR) double-stages differential current signal.

The high-SNR differential current signal generated from the double differential system is shown in FIG. 1c. When a microparticle passes through the centre of a channel from left to right along with the channel distance, it is firstly electrified by an opposite phase voltage from the beginning electrode to the GND electrode. The electrical current signal exhibits a double-peaks shape due to the nonhomogeneous electric field distribution induced by the floating electrode. The height of the valley between the double peaks is positional-dependent on the height of the microparticles flowing through the channel. As microparticles transit through the first GND electrode, a negative peak appears with a much higher current amplitude compared to the previous floating electrode. It indicates that this region has a counter direction of electric field and higher electric field strength. An anti-symmetric electrical current signal appears when microparticles pass the central electrodes with the same mechanism.

The high-SNR differential current signal is divided into two regions. The region from the electrode applied the opposite phase angle voltage to the GND electrode is defined as the position factor region. The region is for calculating the position factor (PF), which is defined:

$$P F = \frac{P - p}{P} . \qquad ( 1 )$$

P is the height of double-peaks, p is the height of the valley. The PF is a real number between 0 to 1, and is used for microparticle size calibration. The other region is defined as the electrical sizing region. The peaks in this region are defined as the raw current amplitude (A). The raw electrical size (RES) is adopted from previous studies:

$$R E S = G {A}^{\frac{1}{3}} . \qquad ( 2 )$$

G is the geometric constant that depends on the channel dimensions (G=2.32 μm μA⁻¹ calibrated by 1.9 μm beads for the proposed system). A previous study has reported that identical microparticles flowing through a channel with different vertical positions result in distinct raw current amplitude due to the nonhomogeneous electrode field generated by coplanar electrodes. This results in comparable raw current amplitude between large microparticles flowing at higher locations of the channel and small microparticles flowing at the locations that are closer to electrodes. Thus, the raw electrical size is not sufficient to size and quantify accurately for samples containing various sizes of particles and needs to be calibrated with the position factor to access precise electrical size profiling. The calibration method will be further elaborated below.

### System Configuration and Device Fabrication

A schematic in FIG. 2a shows the double differential system configuration. The fluidic flow was controlled by a pressure pump (MFCS-EZ, Fluigent). A 5 Vₚₑₐₖ₋ₚₑₐₖ AC voltage with the phase of 0° and 180° at 900 kHz was generated from an impedance spectroscope (HF2IS, Zurich Instrument). The AC voltage with 0° phase angle was applied to the central electrodes, and with 180° phase angle was connected to two side-electrodes. Two GND electrodes were connected to a transimpedance amplifier (HF2TA, 100 kΩ gain). The electrical current signal was transmitted to a differential amplifier (10 kΩ gain) in the impedance spectroscope with a sampling rate of 57.6 k samples per second. The electric signal was then digitalized and sent to a computer for signal processing.

In the impedance sensing region (FIG. 2b), the cross-sectional dimension of the channel was designed in 8 μm (width)×8 μm (height). It was made of PDMS (polydimethylsiloxane) patterned from a 4″ silicon wafer mold. The Cr/Au electrodes (10 nm/100 nm) were deposited on a 4″ glass substrate followed by the standard microfabrication process introduced in the previous work. The electrodes that connect to the AC voltage source, and GND electrodes are 10 μm wide with a spacing of 5 μm from adjacent electrodes. The floating electrodes are 8 μm wide.

### Experiment Setup and Data Analysis

Microsphere beads (0.83, 1.1, 1.43, 1.7, and 1.9 μm in diameter) were diluted respectively in tubes filled with Dulbecco's phosphate-buffered saline (DPBS, Thermo Fisher Scientific, USA) with a concentration of around 5×10⁷ particles per ml. The conductivity of the medium was evaluated to be 1.3 S m⁻¹ by a conductivity meter (Thermo Fisher Scientific, USA). Beads in diameters of 0.83 and 1.7 μm (Magsphere, USA) were non-fluorescent. Beads in diameters of 1.1 (Magsphere, USA), 1.43 and 1.9 μm (Bangs Laboratories Inc., USA) were fluorescent. Three types of mixture samples were prepared including, 0.83, 1.1, and 1.9 μm; 0.83 and 1.9 μm; and 1.43, 1.7, and 1.9 μm. The mixing concentration of each type of beads is even. Beads in a diameter of 1.9 μm were used for calibration in experiments.

The prepared samples were pumped with a driven pressure of 100 mBar. In order to characterize the minimum size sensitivity of the proposed double differential system, the sample mixed with 0.83, 1.1, and 1.9 μm beads, was tested in comparison with the performance of typical three-electrode and floating electrodes configurations. To further indicate the minimum resolution of the proposed system, two mixture samples of 0.83, 1.9 μm beads and 1.43, 1.7, 1.9 μm beads were investigated. Additionally, the samples were examined by a fluorescence-based flow cytometry (MACSQuant, Miltenyi Biotec, Germany) to perform a quantitative comparison with the proposed system on the size distributions of the mixture samples.

A custom-built MATLAB script (MATLAB, Mathworks, USA) was utilized to extract electrical information of single particles, including the position factor and the raw electrical size. It further returned the calibrated electrical size of individual microparticles based on a linear-fitting algorithm of a scatter plot from the position factor against the raw electrical size. Then, the raw electrical size and calibrated electrical size were plotted in histograms and fitted with a standard Gaussian distribution model to access distribution parameters for comparison. In addition, flow cytometry data was processed by FlowJo (BD Biosciences, USA) to obtain size distribution and population ratios of each size of beads in the tested samples for further analysis.

### Biological Sample Preparation

The MDA-MB-231 cell line was purchased from American Type Culture Collection (ATCC No. HTB-26) and cultured with standard protocols discussed previously. To induce apoptosis, MDA-MB-231 cells suspended in 1% BSA were treated with 150 mj/cm² ultraviolet C irradiation (VWR UV crosslinker). UV-exposed cells were incubated in a 37° C./5% CO₂ atmosphere for 12 hours, 24 hours and 48 hours. In each time step, MDA-MB-231 cells were collected and stained with annexin V-FITC (ThermoFisher). Imaging was performed on a Zeiss microscope with ×32 magnification.

### EXAMPLES

### Example 1: Electric Field Strength Enhancement Analysis

Electric field strength is one of the key parameters determining the sensitivity of the microfluidic impedance cytometry for sensing microparticles electrically. FIG. 3a-c illustrate respectively the electric field simulations of three types of electrode configurations by using the finite element modelling (FEM, COMSOL Multiphysics, COMSOL Inc.). FIG. 3a exhibits the simulation of the double differential electrode configuration. The single differential (FIG. 3b) and floating (FIG. 3c) electrodes are based on the double differential configuration. As described, the double differential electrode configuration may be defined as two main regions based on its electrical current signal: position factor region and electrical sizing region. By comparing the electric field strength between two regions in the colour gradient mapping diagram of the simulation in FIG. 3a, the electrical sizing region has higher electric field strength than the position factor region. The results agree with the simulations of the single differential (SD-IMC, FIG. 3b) and the floating (floating-IMC, FIG. 3c) configurations. FIG. 3d illustrates the electric field strength between two neighbouring electrodes of three configurations numerically. The electric field strength of floating electrodes, overlayed by the floating parts of the double differential, is about 50% weaker than the single differential electrodes and the central parts of the double differential electrodes. The reason may be due to the introduction of floating electrodes that lengthen the distance between voltage source and GND electrodes. The weakened electric field strength is expected to have lower sensitivity on microparticle sizing.

Moreover, due to two voltage sources are out of phase by 180°, the potential difference of two voltage sources could become twice as a single voltage source, leading to a doubled electric field strength correspondently to the primary passive differential stage. Thus, virtual double differential electric field strength (dash line) is introduced and presented in FIG. 3d. To experimentally verify the strength of the virtual double differential electric field provided in simulations, the peak height of 1.9 μm beads from the raw impedance data of three configurations are summarized in FIG. 3e. The average peak height of the double differential electrodes is close to 200 nA, while the single electrodes achieve 150 nA. The average peak height of floating electrodes is significantly lower than the other two types of electrodes, which experimentally agrees with the simulation results. FIG. 3f-h demonstrate respectively raw electrical current signals of 0.83, 1.1, and 1.9 μm beads and illustrate that DD-IMC offers the highest peak height of electrical current signal than other two configurations. Therefore, the strongest electric field strength generated in the double differential electrodes could offer the highest sensitivity on microparticle detection, which will be emphasized in the following section.

### Example 2: Improvement of Minimum Particle Size Detection and SNR

To verify the minimum particle size sensitivity of DD-IMC, SD-IMC and floating-IMC, a mixed sample with 0.83, 1.1, and 1.9 μm beads are characterized. An IMC chip is modified in three configurations one after another with the same external electrical settings to ensure identical test conditions. FIGS. 4a and g present raw electrical current signal segments for the double differential and single differential configurations respectively. The SNR of the electrical current signal is utilized for a numerical comparison between electrode configurations and defined in the simplest form as followed:

$$S N R = 10 log ( \frac{{P}_{Signal}}{{P}_{N o i s e}} ) = 10 log [ {( \frac{{A}_{Signal}}{{A}_{N o i s e}} )}^{2} ] = 20 log ( \frac{{A}_{Signal}}{{A}_{N o i s e}} ) . \qquad ( 3 )$$

P_{Signal} is the average power of the electrical current signal. P_{Noise} is the average power of the electrical noise signal. A_{Signal} is the average peak-to-peak amplitude of calibration beads (1.9 μm beads in the experiments). A_{Noise} is the average peak-to-peak amplitude of baseline noise. The electrical current power is illustrated as a square of the average peak-to-peak amplitude of the current signal. The average peak-to-peak amplitude of the noise signal (FIG. 4a) for the double differential is around 8 nA leads to the SNR is 32.64 dB, while it is about 70 nA (FIG. 4d) with the SNR of 13.98 dB for the single differential configuration. The magnifying windows display a sinuous-distorted-shaped noise signal in FIG. 4d of single differential. The noise level is suppressed by the double differential electrodes as shown in the magnifying window of FIG. 4a. Then, the raw electrical size extracted from current signals are plotted in histograms. Due to the advancement of the SNR, FIG. 4b demonstrates clearly three distributions including the beads in diameters of 0.83 μm in the perspective of raw electrical size. In contract, the electrical size distribution of 0.83 μm beads in single differential (FIG. 4d) is overlayed with noise signal. Notably, although a peak of the distribution for 1.1 μm beads is observed for single differential, the distribution is not as isolated as 1.9 μm beads from the electrical noise. This indicates particle quantifying with the raw electrical size is inaccurate using the SD-IMC for microparticles with diameters below 2 μm.

FIGS. 4c and 4f exhibit density plots for double differential and floating electrodes with the position factor against the raw electrical size. As described previously, the electric field strength of floating electrodes is weaker than the other two configurations, leading to a degeneration of the sensitivity on sizing particles. Only 1.9 μm beads form an isolated population. The signal of 1.1 μm beads is melded with the noise signal in FIG. 4f. On the contrary, double differential (FIG. 4c) provide three recognized populations of 0.83, 1.1, and 1.9 μm beads. It is concluded that the proposed DD-IMC system has a superior capability to characterize microparticles down to submicron scale.

Noise suppression has been emphasized in the DD-IMC system of the present disclosure. The SNR defined previously has been summarized (FIG. 4g) for the different frequencies of AC voltage and iron concentrations respectively, applied on the double differential and single differential electrodes. The maximum improvement appears at 900 kHz, that the SNR enhances from 13.98 dB to 32.64 dB for single and double differential electrodes respectively.

The raw electrical current signals of selected frequencies are shown in FIG. 11. An interesting observation happens when the frequency is at 300 kHz. At such low frequency, the electrical current signal of microparticles becomes difficult to identify (SNR=7.95 dB) for the single differential (FIG. 11d). This may be because of the dominance of the EDL effect on the measurement of the current signal. However, under the approach of the double differential, the SNR (16.47 dB) is not only improved, but also higher than the highest SNR (13.98 dB) of the single differential configuration at 900 kHz as shown in FIG. 4g. An improved SNR at 300 kHz may suggest that the proposed electrode configuration is able to compensate for the electrical current noise induced by the EDL effect. This realizes particle sizing at low frequencies with suppressed electrical noise. It is significant for characterizing biological samples. Different biological samples may have different membrane capacitance, due to their membrane thickness and compositions, leading to a different membrane-permeabilized frequency. Therefore, the proposed double differential system offers an opportunity using a broad range of frequencies of applied AC voltage for precise size characterization while maintaining good SNR for various types of biological samples. To further characterize the performance on EDL effect suppression with the proposed DD-IMC system, SNR of double and single electrodes under different PBS concentrations was investigated (FIG. 4g and FIG. 12). The largest improvement of SNR is at 1×PBS. For 10×PBS, the EDL effect becomes more significant to low concentration of PBS because of higher relaxation frequency. But the proposed double differential configuration can still provide higher SNR than the conventional single differential configuration.

### Example 3: Promotion of Minimum Particle Size Resolution by Position Factor Calibration

FIG. 5a shows the normalized raw electrical size against the position factor for 1.9 μm beads. The normalization is defined as:

$$N E S = \frac{{RES}_{measured}}{Bead {Size}_{c a l}} . \qquad ( 4 )$$

NES is the normalized electrical size, RES_{measured} is the raw electrical size measured by the IMC chip. Bead Size_{cal} is the size of the calibration bead (1.9 μm in the experiments). A double-peaks shape of the distribution in the histogram of FIG. 5a may be caused by the variation of the vertical locations of beads in the sensing channel, which has been discussed previously. The scattered data can be fitted to a linear function:

$$N E S = {c}_{1} \times P F + {c}_{2} . \qquad ( 5 )$$

In the above, c₁ and c₂ are the calibration factors used to calculate the calibrated electrical size. Since the linear fitting is performed with the normalized electrical size, the fitting parameters (c₁ and c₂) can be universally applicable to other sizes of beads characterized by the same IMC chip. FIG. 5b illustrates the calibrated electrical size of 1.9 μm beads that can be obtained from:

$$Calibrated ES = \frac{R E {S}_{measured}}{{c}_{1} \times P F + {c}_{2}} . \qquad ( 6 )$$

Calibrated ES is the calibrated electrical size. After calibration, the distribution of the electrical size is a normal distribution with a mean of about 1.9 μm.

The proposed size calibration method is utilized for calibrating the raw electrical size of mixture samples including 0.83, 1.9 μm beads, and 1.43, 1.7, 1.9 μm beads. The distributions of all types of beads before calibration (FIGS. 6a and 6b) are an inclined shape comparing to the calibrated populations (FIGS. 6c and 6d) that distribute vertically. FIGS. 6e and 6f indicate smaller standard deviation of the electrical size distributions and overlapping areas to neighbouring distributions after calibration. To analyze the improvement of calibration quantitatively, the histograms of beads before and after calibration are fitted by a standard Gaussian distribution in FIG. 13 and FIGS. 6e and 6f, respectively. The fitting parameters are summarized in Table 1. The means of the Gaussian distributions after calibration are close to the actual bead size (<2% difference). Their standard deviations for calibrated results are similar, because of the similar manufacturing processes. In contrast, the means of 1.43 and 1.7 μm beads before calibration are smaller than the actual sizes and the after-calibration results (˜ 10% difference). The standard deviation reduces more than 50% for 1.7 and 1.9 μm beads after size calibration.

The inaccuracy of means may be because of large standard deviation of the raw electrical size distributions. In addition, the overlapping coefficient, a ratio of the overlapping area with neighbouring distributions to the electrical size distribution of respective beads, indicates 69.368% on the size distribution of 1.43 μm beads before calibration shown in FIG. 13b, while only 2.872% after calibration in FIG. 6f. The overlapping coefficient for the calibrated electrical size distribution of 1.7 and 1.9 μm beads are less than 0.3% (FIG. 6f) comparing to 11.503% and 26.119%, respectively, before calibration. Thus, the proposed double differential system with the calibration method is capable to not only provide size information accurately, but also reduce the size resolution down to 200 nm.

TABLE 1
Gaussian fitting results for FIG. 6(e) and (f), and FIG. 12

| | Before Calibration | | | | After Calibration | | | |
|---|---|---|---|---|---|---|---|---|
| Bead Size | Mean | Std | Overlapping Coefficient | | Mean | Std | Overlapping Coefficient | |
| 0.8 um | 0.88147 | 0.141218 | N.A. | | 0.844 | 0.102371 | N.A. | |
| 1.43 um | 1.22 | 0.059195 | 69.368% | | 1.419 | 0.084304 | 2.872% | |
| 1.7 um | 1.523 | 0.244992 | 6.030% | 11.503% | 1.694 | 0.079935 | 1.532% | 0.227% |

| | | | | | | |
|---|---|---|---|---|---|---|
| 1.9 um | 1.9 | 0.153233 | 26.119% | 1.9 | 0.07549 | 0.281% |

The population ratios of each size of beads in the mixture samples are characterized by commercial fluorescence-based flow cytometry to perform quantitative verification. The population ratio reported by the proposed DD-IMC system is calculated from the area of the Gaussian distribution of each types of beads to the total areas of the distributions in the samples. The results given by fluorescence-based flow cytometry is calculated based on the number of particles at different intensity of fluorescence to the total number of characterized particles. FIG. 6g shows the mixture sample of 0.83 and 1.9 μm beads. Two types of beads can be differentiated by both forward scattering and fluorescence. The population ratios given by IMC system conclude that 1.9 μm beads are 36.9% and 0.83 μm beads are 63.1%, agreed by fluorescence-based flow cytometry (38.1% and 61.9%, respectively). FIG. 6h demonstrates the mixture sample of 1.43, 1.7, 1.9 μm beads. The distribution of 1.7 and 1.9 μm beads are highly overlapped and cannot be distinguished in forward scattering, while the intensity of fluorescence discriminates three types of beads. The distribution of 1.43 μm beads in forward scattering also has a part of the area overlapping with two other distributions. This indicates that forward scattering is insufficient to distinguish samples in size with difference in submicron scale unless staining microparticles. Further, the proposed IMC system tells that that 1.9 μm beads are 34.6%, 1.7 μm beads are 42.9%, and 1.43 μm beads are 22.5%, agreed by the fluorescence-based flow cytometry (35.6%, 41.9% and 22.5%, respectively).

### Example 4: Submicron Accuracy Profiling

The coefficient of variation (CV) measured by the proposed double differential system for 0.83, 1.43, 1.7, 1.9 μm are 12.1%, 5.9%, 4.7%, 4%, respectively, which are calculated from a ratio of standard deviations to means in Table 1. The CVs are smaller than the datasheet claimed by the manufacturers, which are 15%, 10%, 10%, 10%. This may be because the specifications in manufacturing datasheets are more conservative than actual manufacturing parameters. FIG. 7a shows a comparison of the calibrated electric size against datasheet size. A linear fitting curve is overlayed on the figure with a slope that is close to 1 and an intersection to y-axis that is close to 0. This indicates the calibrated electrical sizes correlate to the datasheet sizes (R²=0.99938). P-values indicated in FIG. 7b validate the sizes of characterized beads are not significantly different between the double differential system and manufacturers' datasheets. The results of 1.9 μm beads does not show a p-value since it is the calibration bead.

### Example 5: Characterization of Apoptotic Bodies Formation in Timecourse of 48 Hours

To demonstrate the performance of the proposed device on characterizing biological samples, the size distribution and concentration of MDA-MB-231 apoptotic bodies characterized by the proposed DD-IMC, conventional SD-IMC and commercial fluorescence-based flow cytometry were investigated. Apoptotic bodies are generated by the fragmentation of UV-induced apoptotic MDA-MB-231 cells (FIG. 8a). Secondary necrosis could further disassemble large apoptotic bodies to smaller apoptotic bodies if they are not eliminated by phagocytosis, which may further reduce the average size of apoptotic bodies. Flow cytometry analysis shows apoptotic bodies, purified from an apoptotic whole cell sample by eliminating viable and apoptotic cells, have a size distribution (FSC) close to 1 μm fluorescent beads (FIG. 8b). FIG. 8c shows that the formation of apoptotic bodies (Annexin V positive) grows with a longer incubation time. The FITC fluorescence could also help flow cytometry to obtain the concentration of apoptotic bodies precisely. FIG. 8d demonstrates the size distribution of apoptotic bodies characterized by DD-IMC and SD-IMC. The proposed DD-IMC quantifies the number of apoptotic bodies in 24 hours and 48 hours that are about 3 times higher than 12 hours with the minimum detectable size of 0.4 μm, and the size distribution of apoptotic bodies incubated for 24 and 48 hours is wider than 12 hours (FIG. 14 shows the original histogram of size distribution of DD-IMC). In contrast, the conventional single differential only measures incomplete apoptotic bodies with a minimum size of 1.6 μm. The concentration of apoptotic bodies measured by DD-IMC is consistent to the results of fluorescence-based flow cytometry (FIG. 8e). A slight reduction of concentration in DD-IMC could because some apoptotic bodies may smaller than 0.4 μm (the minimum detectable size of DD-IMC). The DD-IMC system shows the size of apoptotic bodies reduces in 48 hours, that concur with FSC in fluorescence-based flow cytometry (FIG. 8f). A more significant size reduction of apoptotic bodies from 12 hours to 48 hours detected by DD-IMC indicates a higher minimum size resolution than commercial fluorescence-based flow cytometry.

### Example 6: Bacteria Viability and Gram Strain Characterization

Viability assay and gram types identification were demonstrated with the proposed double differential electrodes (FIG. 9). The opacity (45 MHz/1 MHZ) of viable E. coli (dash line in FIG. 9a) is at the central of 0.7 with the calibrated electrical size of 1.1 μm. Whereas the fixed (dead) E. coli can be identified and clustered with the opacity that increases to 1.1 in the mixture sample (solid line in FIG. 9a). Furthermore, the electrical characterization (FIG. 9b) on the mixture of gram-positive bacteria (L. monocytogenes) and gram-negative bacteria (E. coli) illustrates a significant increase in the opacity of L. monocytogenes (1.22) compared to E. coli (0.7). The increased opacity is because the thicker cell wall of gram-positive strain compared to gram-negative strain results an increase in the magnitude of impedance at 45 MHz. Therefore, the proposed double differential electrodes can be utilized to perform bacteria viability assay and gram strain differentiation in a label-free manner. This could potentially impact the areas of antimicrobial susceptibility test for antibiotics screening and environmental monitoring with an ultimate low-cost coplanar double differential electrodes.

### Example 7: Leukocyte 3-Parts Classification

The proposed double-differential electrode is utilized for 3-part leukocyte classification and quantification with the leukocyte enriched sample (FIG. 10a). The leukocyte impedance data clustering is based on electrical properties, such as the opacity (25 MHz/260 kHz), the phase at 8 MHz, and electrical size ((Magnitude_{260 kHz})^{1/3}). Human peripheral blood cells (PBMCs) are the control sample to verify the classification, as PBMCs only consist of lymphocytes and monocytes. The subsets of PBMCs can be indicated and identified as lymphocytes (smaller electrical diameters, 8 μm) and monocytes (larger electrical diameters, 12 μm) by the 80% contour plot in FIG. 10b, as previous literature reported that monocytes have larger diameters to lymphocytes. It is worth noting that lymphocytes and monocytes show similar opacity at 0.65, which may indicate two types of cells with comparable cytoplasm conductivity. The 3 subtypes of leukocytes can be identified by the 80% contour plot in the leukocyte enriched sample (FIG. 10c). It is noticed that the opacity of one cluster (mean=0.75) is higher than the other two clusters (mean=0.65), whereas the other two clusters show the average opacity that is close to the impedance data in PBMCs (mean=0.65). By combining two contour plots from PBMCs and the leukocyte enriched sample (FIG. 10d), lymphocytes and monocytes can be determined as they have coincided clusters. The cluster with higher opacity (mean=0.75) can be distinguished as granulocytes. The similar cell diameters between monocytes and granulocytes are agreed upon by other studies. With the manual gating on the leukocyte from the whole blood (FIG. 10e), the frequencies of lymphocytes, monocytes, and granulocytes are 43.8%, 11.2%, and 44.9%, respectively.

The leukocyte enriched sample is also tested in flow cytometry with fluorescence labelling, forward and side scattering (FSC/SSC) in a label-free manner (FIG. 10f). The results of flow cytometry also indicate that erythrocytes create a lot of noise in the FSC/SSC plot. It is difficult to identify the subtypes of leukocytes without fluorescence labelling. In the comparison of different approaches in 3-part LDC (FIGS. 10g and 10h), the proposed double differential electrode provides the frequencies and concentrations (lymphocytes: 1057 cells/μl; monocytes: 272 cells/μl; granulocytes: 1083 cells/μl) of 3 subtypes of leukocytes that is similar to the fluorescence-labelling approach (lymphocytes: 42.1%, 916 cells/μl; monocytes: 8.7%, 221 cells/μl; granulocytes: 49.5%, 1073 cells/μl). A significantly low lymphocyte count (30.4%, 713 cells/μl) is presented by the conventional position-sensitive device indicating that the accuracy of 3-part LDC is insufficient and could result in misdiagnose with the position-sensitive device. The FSC/SSC approach brings a significantly high frequency (64.5%, 5210 cells/μl) and counting of lymphocytes, caused by the overlapping noise brought by erythrocytes. The results from the FSC/SSC approach indicate that the current laser-based flow cytometry cannot provide sufficient accuracy of label-free 3-part LDC without erythrocyte lysis.

### CONCLUSION

In summary, the novel impedance-based microfluidic flow cytometry system integrated with the double differential configuration electrodes has been demonstrated for high-throughput label-free microparticles sizing and quantifying with submicron precision. The system has shown a significant enhancement of electric field strength enabling the highest sensitivity for submicron-precision particle detection down to 0.4 μm as compared to the conventional electrode designs. With the proposed calibration method and the double differential electrode configuration, an improvement of size measurement accuracy has been demonstrated in terms of mean and standard deviation promoting the minimum resolution for distinguishing microparticle size difference down to 200 nm. With the double differential system, we have characterized and obtain accurate size distributions and population ratios of microparticles in submicron scale, which previously can only be distinguished by fluorescence staining in commercial flow cytometry. The calibrated electrical size resulted from the proposed system is statistically consistent with the manufacturers' datasheets. The demonstration on sizing and counting apoptotic bodies shows that the proposed DD-IMC has the performance surpassing conventional three-electrode IMC and provides similar concentration measurement to commercial fluorescence-based cytometry but with a label-free manner. Furthermore, the new double differential IMC has promoted an ability of suppressing electrical noise in a range of sub-MHz to MHz. It emphasizes a feature of using low frequencies to characterize, size and quantify microparticles in submicron scale by compensating the SNR degradation induced by the EDL effect. With the ensemble of the above features, this proposed system thus furnishes a new avenue for biomedical and clinical applications that require rapid and real-time sizing and quantifying of biological samples in a size range of submicron to micron.

With the advantages of rapid and accurate processing of electrical signal and high throughput of the impedance flow cytometry, various example embodiments as described may be easily integrated with other microfluidic platforms, for example, as a downstream approach for the real-time measurement of the physical properties of single cells and particles.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

### REFERENCES

1. Zhong, J., Liang, M., & Ai, Y. (2021). Submicron-precision particle characterization in microfluidic impedance cytometry with double differential electrodes. Lab on a Chip.
2. Zhong, J., Tang, Q., Liang, M., & Ai, Y. (2022). Accurate profiling of blood components in microliter with position-insensitive coplanar electrodes-based cytometry. Sensors and Actuators B: Chemical.

1. An impedance-based microfluidic flow cytometry device comprising:
a channel comprising a sensing region to sense a particle flowing through the channel; and
an electrode arrangement disposed adjacent the sensing region,
wherein the electrode arrangement is configured to generate within the sensing region at least one first region of differential current and at least one second region of differential current, and wherein the at least one first region and at least one second region have opposite phases of electric current.

2. The device of claim 1, wherein the electrode arrangement comprises:
a central electrode;
two ground electrodes disposed adjacent the central electrode on opposite sides of the central electrode; and
two end electrodes disposed adjacent the ground electrodes on the sides opposite to the central electrode,
wherein a first region of the at least one first region is generated between each ground electrode and the adjacent end electrode, and
wherein a second region of the at least one second region is generated between the central electrode and each adjacent ground electrode.

3. The device of claim 2, wherein the electrode arrangement further comprises a floating electrode disposed intermediate a ground electrode and an end electrode.

4. The device of claim 2, wherein the electrode arrangement further comprises two floating electrodes, wherein each of the two floating electrodes is disposed intermediate a ground electrode and an end electrode.

5. The device of any one of claims 2 to 4, wherein the central electrode is connected to an AC voltage source with 0° phase angle and wherein the two end electrodes are connected an AC voltage source with 180° phase angle.

6. The device of any one of claims 2 to 5, wherein the device comprises a further central electrode.

7. The device of any one of the preceding claims, wherein the electrodes are spaced about 1-20 μm apart.

8. The device of any one of the preceding claims, wherein the electrodes are about 2-30 μm in width.

9. A method of determining a characteristic of a particle in a fluid suspension, the method comprising:
(a) providing
i) a channel for receiving and allowing the fluid suspension to flow through, the channel having a sensing region; and
ii) an electrode arrangement disposed adjacent the sensing region;
(b) applying a voltage to one or more electrodes in the electrode arrangement to generate within the sensing region at least one first region of differential current and at least one second region of differential current, and wherein the at least one first region and at least one second region have opposite phases of electric current;
(c) obtaining a differential electrical signal generated by the electrode arrangement as the particle flows through the sensing region; and
(d) determining the characteristic of the particle based on the differential electrical signal.

10. The method of claim 9, wherein the electrode arrangement comprises:
a central electrode;
two ground electrodes disposed adjacent the central electrode on opposite sides of the central electrode; and
two end electrodes disposed adjacent the ground electrodes on the sides opposite to the central electrode,
wherein a first region of the at least one first region is generated between each ground electrode and the adjacent end electrode, and wherein a second region of the at least one second region is generated between the central electrode and each adjacent ground electrode.

11. The method of claim 10, wherein the electrode arrangement further comprises a floating electrode disposed intermediate a ground electrode and an end electrode.

12. The method of claim 10, wherein the electrode arrangement further comprises two floating electrodes, wherein each of the two floating electrodes is disposed intermediate a ground electrode and an end electrode.

13. The method of any one of claims 10 to 12, wherein step (b) comprises applying an AC voltage with 0° phase angle to the central electrode and applying an AC voltage with 180° phase angle to the two end electrodes.

14. The method of any one of claims 10 to 13, wherein the device comprises a further central electrode.

15. The method of any one of claims 10 to 14, wherein in step (c), the differential electrical signal is received by the two ground electrodes.

16. The method of any one of claims 9 to 15, wherein the differential electrical signal is further differentiated with a differential amplifier after step (c).

17. The method of any one of claims 9 to 16, wherein determining the characteristic of the particle comprises determining the size of the particle and wherein the method further comprises a step of calibrating the size of the particle.

18. The method of any one of claims 9 to 17, wherein determining the characteristic of the particle comprises determining the quantity of the particle.

19. The method of any one of claims 9 to 18, wherein determining the characteristic of the particle comprises identifying the particle.

20. The method of any one of claims 9 to 19, wherein the particle is a biological particle.
